(19) United States
(12) Patent Application Publication
(10) Pub. No.: US 2011/0004676 A1
(43) Pub. Date: Jan. 6, 2011

(54) VIRTUAL APPLIANCE DEPLOYING SYSTEM

(76) Inventor: Masahiro Kawato, Tokyo (JP)

Correspondence Address: Mr. Jackson Chen, 6535 N. STATE HWY 161, IRVING, TX, 75039, US

(21) Appl. No.: 12/865,907

(22) PCT Filed: Jan. 6, 2009
(86) PCT No.: PCT/JP2009/050011

§ 371 Date: Aug. 3, 2010

(30) Foreign Application Priority Data
Feb. 4, 2008 (JP) 2008-024394

(51) Int. Cl. G06F 15/177; G06F 9/455

(52) U.S. Cl. 709/221; 718/1

(57) ABSTRACT

In deployment of a virtual appliance to a physical server, a setting file required for the virtual appliance to operate is automatically generated based on a configuration of the physical server and a network configuration, and connection relation between the virtual appliances. Specifically, resource data assigned to the virtual appliance and connection data are registered on a configuration data database, and a template of the setting file is set in advance to a virtual machine image for the virtual appliance. In the deployment of the virtual appliance to the physical server, optional attributes described in the template of the setting file are replaced by specific setting values (actual data) by using the resource data and the connection data stored in the configuration data database, to generate the setting file.

### TECHNICAL FIELD

The present invention relates to virtual appliance deploying systems, and in particular, to a virtual appliance deploying system of setting a connecting relation among a plurality of virtual appliances and a connecting relation between the virtual appliance and a peripheral service.

### BACKGROUND ART

An example of the virtual appliance deploying system has been described in a document of “Virtual Appliances for Deploying and Maintaining Software” (Proceedings of the 17th Large Installation Systems Administration Conference, 2003) written by Constantine Sapuntzakis, David Brumley, Ramesh Chandra, Nickolai Zeldovich, Jim Chow, Monica S. Lam, and Mendel Rosenblum.

In the technique described in the above Non-Patent Literature, a system of deploying virtual appliances (VAs) is proposed as means of reducing time and effort on introducing and maintaining software. The appliance means a device provided as a combination of a hardware unit and a software unit operating thereon. The appliance has a feature of being immediately used without a software installation operation. The virtual appliance realizes effects similar to the appliance without dedicated hardware by incorporating software in advance into a virtual machine operating on a virtual machine monitor, such as “VMware (registered trademark)”.

Furthermore, in the technique described in the above document, a system of deploying a virtual appliance network obtained by combining a plurality of virtual appliances is proposed.

Specifically, in the virtual appliance deploying system according to the technique described in the above Non-Patent Literature, a system manager uses a language called “Collective Virtual Appliance Language (CVL)” to describe data of physical server equipments, which are virtual appliance deployment destinations, and data of network configuration, and a connecting relation between the virtual appliances. Based on this data, the virtual appliance deploying system automatically executes an introducing operation and an environment configuring operation for each VA (virtual appliance).

Here, regarding the virtual appliance deploying system according to the technique described in the above document, there can be problems as follows.

A first problem is in that, in order to automate a setting operation depending on application software operating on a virtual appliance, it is required to prepare a different setting program for each type of application.

A second problem is in that an operation of changing settings cannot be automatically performed for different software used in combination with the virtual appliance to be deployed. This is because a target upon updating a setting file is restricted to a virtual appliance to be deployed, and virtual appliances having no direct connection relation are not the target of the setting change.

As an example of a combination of these types of software, a combination could be considered of a Web application operating on a virtual appliance and a portal Web server operating on another server device. A system user first connects to the portal Web server to obtain a URL (Uniform Resource Locator) indicating a link to the Web application on the virtual appliance, and then connects to the Web application on the virtual appliance by using that link. In the system of this type, when a virtual appliance is deployed, a link to the Web application on the virtual appliance needs to be added as the contents of the portal Web server.

As another example of software used in the above combination, there are assumed a Web application operating on the virtual appliance and a Name Server managing a correspondence between a host name and an IP (Internet Protocol) address. When the system user connects to the Web application through a Web browser, it is required to convert the host name included in a URL assigned to the Web application to the IP address. This converting process is executed by the name server. Therefore, when a virtual appliance is deployed, it is necessary to add data of the host name and the IP address of the virtual appliance to a table indicating correspondence between the host name and the IP address used by the name server.

In conjunction with the above description, a virtual machine control system is disclosed in JP 2005-332223A. In this related technique, the virtual machine control server of a master image managing section, a group managing section, and a file management DB (Database) receives an instruction of a virtual machine manager from a client terminal through a communication control section. The master image managing section controls the master image file server and the master image file management DB to register, change, or delete a master image file obtained from the virtual machine server. The group managing section controls the group management DB to register, change, delete, or duplicate a group. A group deploying section refers to the group management DB to deploy a virtual machine on a virtual machine server.

Also, a system for centralized software management in a virtual machine is disclosed in JP 2006-221649A (Patent Literature 2). In this Patent Literature 2, a virtual machine of a virtual data center generates a runtime instance from a software image, hardware configuration, management configurations, and user/service configuration. Usage of resources in the virtual data center is monitored by referring to a management configuration of runtime instances for environment control such as controls of power, cooling, and balancing, and a management configuration of runtime instances for policy limitations on software or hardware. A user or service generates the runtime instance for a virtual machine by referring a user/service configuration such as price or priority.

Moreover, a software distributing server is disclosed in JP 2007-079773A. In this related technique, the software distribution server has a package database storing therein a package and auxiliary software required for operating package software, with at least one of an update date of the package and a package version being taken as management data. Also, the software distribution server has a dependence list storage unit storing a dependence list, which is a list of auxiliary software programs required for operation of the package, with at least one of the date and the version being taken as management data. Further, the software distribution server has a distribution control section that, upon receiving a request for obtaining a package with its date or version specified from a client, transmits the dependence list of the relevant package to the client and distributes the auxiliary software programs and package requested from the client to the client.

Further, a file generating and distributing method and an install server are disclosed in JP 2007-193696A. In this related technique, a meta package generates installation settings for automatic installation of a plurality of software programs for each of a plurality of clusters, and also generates and distributes an IDS (Intrusion Detection System) configuration file for supporting software management after installation. Thus, the installation setting is generated from a template of setting data for the plurality of software programs and customization data supplied from outside and, an IDS configuration file is generated based on the generated installation setting, to be used in an inspection after the plurality of software programs are automatically installed. This IDS configuration file is distributed to an installation destination together with an IDS configuration file prepared at the time of generation of a meta package.

### DISCLOSURE OF THE INVENTION

In the present invention, in deployment of a virtual appliance to a physical server, an environment constructing operation depending on the configuration of the physical server as a deployment destination and a network configuration can be automatically performed without using a setting program dedicated to an individual type of virtual appliance.

A virtual appliance deploying system of the present invention includes a virtual appliance control apparatus including a resource data storage section, a connection data storage section, and a VM (virtual machine) image generating section; a configuration data DB (database) storing resource data and connection data; a VM image repository storing a VM image required for an operation of a virtual appliance; and a plurality of VM servers.

In the VM image repository, a VM image template serving as a base for generating a VM image corresponding to each VA is stored in advance. A different point between a VM image to be deployed and the VM image template is in that, in the VM image template, a setting file depending on physical configuration and a connecting relation among VA instances is stored in a form of a setting file template.

Prior to deployment of a VA instance, the virtual appliance control apparatus stores resource data to be assigned to the VA instance to be deployed and connection data indicating a connecting relation among the VA instances in the configuration data DB by using a resource data storing section and a connection data storing section. Moreover, in deploying a VA instance, the virtual appliance control apparatus uses the VM image generating section to generate a VM image including a setting file depending on physical configuration and the connecting relation among the VA instances, from the VM image template in the VM image repository and the resource data and the connection data stored in the configuration data DB.

A VA to be deployed includes a resource data solving section and a setting updating section. The resource data solving section refers to the contents of the configuration data DB and a setting file template provided in advance to periodically update the setting file required for an operation of a server program on the VA. By this mechanism, it is made possible to generate the setting file at an application level, which would be impossible on a VM image, and to adapt to a configuration change after deployment.

Further, as with the VA, a peripheral service such as a name server and a portal Web server, includes the resource data solving section and the setting updating section. With these sections, when new VA instances are deployed, name solution for these VA instances and addition of a new VA to a service menu are automatically performed.

With this, in deploying a virtual appliance to a physical server, a setting operation depending on physical configuration and logic configuration can be automated, including the setting file required for a specific application.

### BRIEF DESCRIPTION OF DRAWINGS

FIG. 1 is a block diagram showing the configuration of a virtual appliance deploying system according to an exemplary embodiment of the present invention;

FIG. 2 is a block diagram showing an internal configuration of the virtual appliance control apparatus for use in the virtual appliance deploying system according to the exemplary embodiment of the present invention;

FIG. 3 is a block diagram showing an internal configuration of a VM server used in the virtual appliance deploying system according to the exemplary embodiment of the present invention;

FIG. 4 is a block diagram showing an internal configuration of a name server used in the virtual appliance deploying system according to the exemplary embodiment of the present invention;

FIG. 5 is a block diagram showing an internal configuration of a portal Web server used in the virtual appliance deploying system according to the exemplary embodiment of the present invention;

FIG. 6 is a sequence diagram showing a service usage procedure used in the virtual appliance deploying system according to the exemplary embodiment of the present invention;

FIG. 7 is a sequence diagram showing an operation procedure of the virtual appliance control apparatus used in the virtual appliance deploying system according to the exemplary embodiment of the present invention;

FIG. 8 is a diagram showing a VA instance identifying method used in the virtual appliance deploying system according to the exemplary embodiment of the present invention;

FIG. 9 is a state transition diagram showing a relation between manager screens used in the virtual appliance deploying system according to the exemplary embodiment of the present invention;

FIG. 10 is a diagram showing an example of a VA package search screen outputted from an operation section used in the virtual appliance deploying system according to the exemplary embodiment of the present invention;

FIG. 11 is a diagram showing an example of a VA instance generation screen outputted from the operation section used in the virtual appliance deploying system according to the exemplary embodiment of the present invention;

FIG. 12 is a flowchart showing an operation procedure of a VA package instance process used in the virtual appliance deploying system according to the exemplary embodiment of the present invention;

FIG. 13 is a diagram showing an example of a VA instance deployment screen outputted by the operation section used in the virtual appliance deploying system according to the exemplary embodiment of the present invention;

FIG. 14 is a diagram showing a storage format of resource data and connection data used in the virtual appliance deploying system according to the exemplary embodiment of the present invention;

FIG. 15 is a diagram showing a VM image stored in a VM image repository used in the virtual appliance deploying system according to the exemplary embodiment of the present invention;

FIG. 16 is a flowchart showing an operation procedure of the VM image generating section used in the virtual appliance deploying system according to the exemplary embodiment of the present invention;

FIG. 17 is a table showing an example of details of a configuration data DB used in the virtual appliance deploying system according to the exemplary embodiment of the present invention;

FIG. 18 is a flowchart showing an operation procedure of a setting control section of a VA instance used in the virtual appliance deploying system according to the exemplary embodiment of the present invention;

FIG. 19 is a flowchart showing an operation procedure of a setting control section of the name server used in the virtual appliance deploying system according to the exemplary embodiment of the present invention; and

FIG. 20 is a flowchart showing an operation procedure of a setting control section of the portal Web server used in the virtual appliance deploying system according to the exemplary embodiment of the present invention.

### BEST MODE FOR CARRYING OUT THE INVENTION

Hereinafter, a virtual appliance deploying system according to the present invention will be described with reference to the attached drawings.

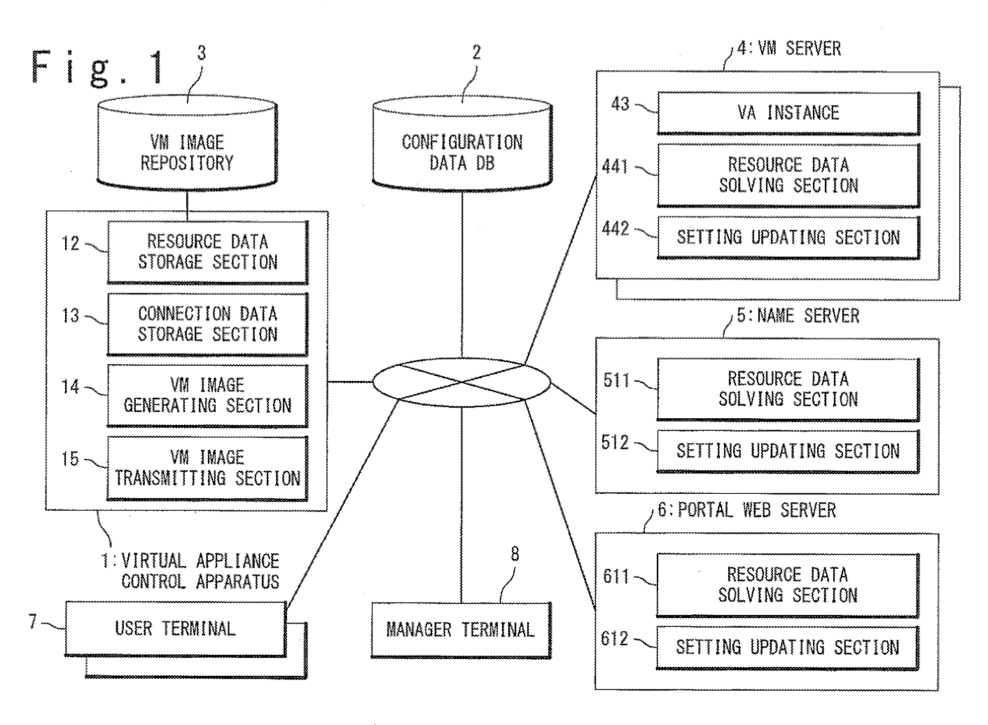

Referring to FIG. 1, the virtual appliance deploying system according to an exemplary embodiment of the present invention includes a virtual appliance control apparatus 1, a configuration data DB (database) 2, a VM (virtual machine) image repository 3, VM servers 4, a name server 5, a portal Web server 6, user terminals 7, and an manager terminal 8.

Among these units, the units (the virtual appliance control apparatus 1, the configuration data DB 2, the VM servers 4, the name server 5, the portal Web server 6, the user terminals 7, and the manager terminal 8) other than the VM image repository 3 are connected to each other through a network. The VM servers 4, the name server 5, and the portal Web server 6 are server apparatuses. Also, the VM servers 4 each have a function of operating one or more VMs. Moreover, the user terminals 7 and the manager terminal 8 each include an input unit such as a keyboard and a mouse, and an output unit such as a display. The VM image repository 3 is a storage unit connected to the virtual appliance control apparatus 1.

As examples of the virtual appliance control apparatus 1, the configuration data DB 2, the VM servers 4, the name server 5, and the portal Web server 6, computers are assumed as a PC (personal computer), a thin client server, a work station, a main frame, or a supercomputer. Also, as examples of the user terminals 7 and the manager terminal 8, computers such as a PC, a thin client terminal, or electronic devices such as a mobile phone, a car navigator (car navigation system), a portable game machine, a home-use game machine, an information home appliance, a POS (Point of Sales) terminal, an OA (Office Automation) equipment, or those having a similar communicating function can be assumed. Here, each of these units may be mounted on a mobile body such as a vehicle, a ship, or an aircraft. Also, each unit is not restricted to a terminal or a server, but can be a relay unit or a peripheral device. Moreover, each unit may be an extension board or software installed on a computer. It should be noted that these units are not restricted to the above examples.

As an example of the network connecting the respective units, the Internet, a LAN (Local Area Network), a radio LAN (Wireless LAN), a cable television (CATV) line, a fixed telephone network, a mobile phone network, WiMAX, 3G (third-generation mobile phone), or a dedicated line can be assumed. It should be noted that the network is not restricted to the above examples.

Each of these units generally operates as follows.

### <Virtual Appliance Control Apparatus 1>

The virtual appliance control apparatus 1 stores resource data associated with a new VA instance in the configuration data DB 2 based on a VA instance generating operation supplied from the manager terminal 8, and distributes a VM image configuring the VA instance to the VM server 4. These VM images are obtained by applying resource data of an OS (Operating System) level such as a host name and an IP address to the VM images stored in the VM image repository 3.

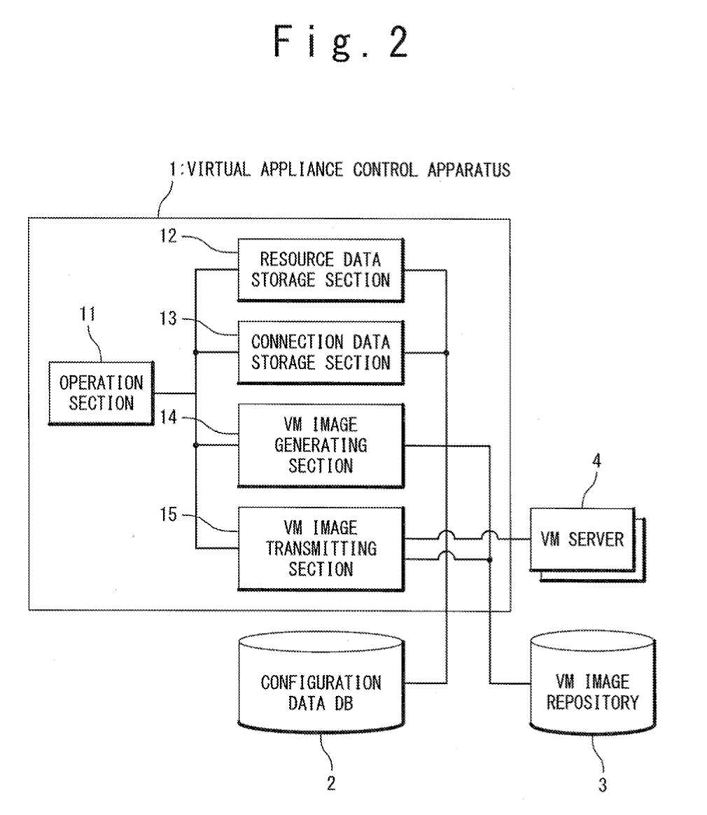

Referring to FIG. 2, the internal configuration of the virtual appliance control apparatus 1 will be described.

The virtual appliance control apparatus 1 includes an operation section 11, a resource data storage section 12, a connection data storage section 13, a VM image generating section 14, and a VM image transmitting section 15.

The operation section 11 receives an operation for generation of a new VA instance from the manager terminal 8, and also calls each of functions of the virtual appliance control apparatus 1 (the resource data storage section 12, the connection data storage section 13, the VM image generating section 14, and the VM image transmitting section 15) according to the received operation. The resource data storage section 12 stores resource data supplied through the operation section 11 in the configuration data DB 2. The connection data storage section 13 stores connection data supplied through the operation section 11 in the configuration data DB 2. The VM image generating section 14 generates a VM image for a VA instance to be newly generated based on the VM image stored in the VM image repository 3. The VM image transmitting section 15 transmits the VM image generated by the VM image generating section 14 to the VM server 4.

### <Configuration Data DB 2>

The configuration data DB 2 is a database that stores resource data and connection data with other VA instances for each VA instance. As described above, the configuration data DB 2 holds data supplied from the virtual appliance control apparatus 1. The configuration data DB 2 provides the held data to each of VA instances operating on the VM servers 4, the name server 5, and the portal Web server 6.

### <VM Image Repository 3>

The VM image repository 3 is a storage that stores a VM image corresponding to each VA. Two types of VM images are stored in the VM image repository 3: one is VM images having stored in advance in the VM image repository 3 and the other is VM images generated by the VM image generating section 14 for specific VA instances.

### <VM Servers 4>

The VM server 4 is a computer operating under program control, and also has a function of operating at least one VM. In this example, there are a plurality of the VM servers 4. Each VA instance operates as a VM on a specific one of the VM servers 4.

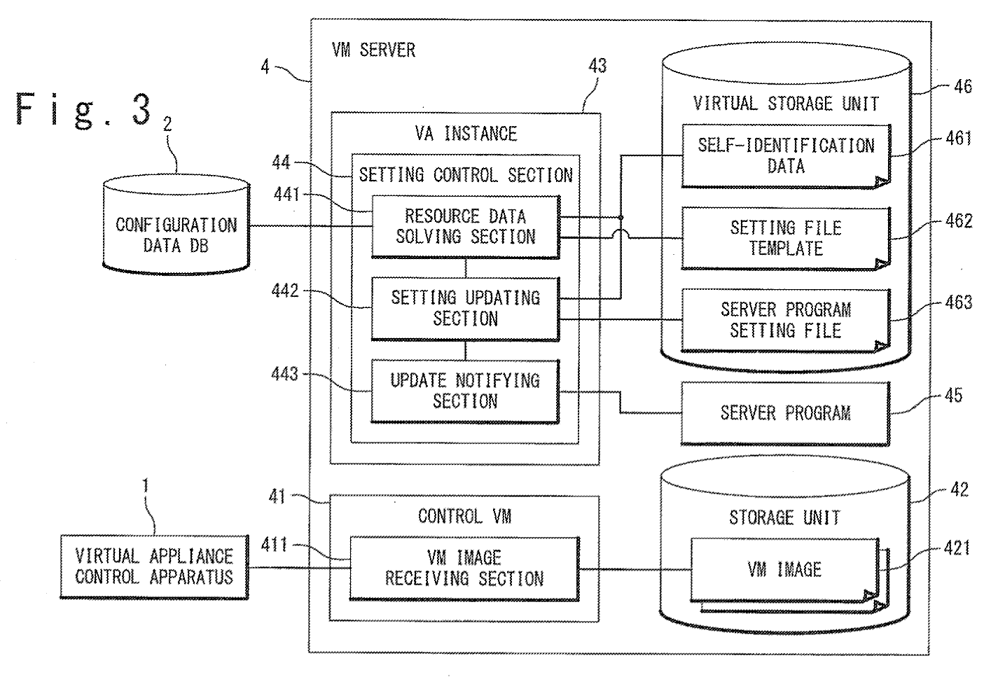

Referring to FIG. 3, the internal configuration of the VM server 4 will be described.

The VM server 4 includes a control VM 41, a storage unit 42, at least one VA instance 43, a setting control section 44 included in each VA instance, and a virtual storage unit 46 connected to each VA instance.

The control VM 41 is one of VMs operating on the VM server 4, and is a special VM capable of directly controlling physical hardware resources (such as a CPU, a memory, and a storage unit) configuring the VM server 4. Also, the control VM 41 includes a VM image receiving section 411. The VM image receiving section 411 receives a VM image transmitted from the VM image, transmitting section 15 to store in the storage unit 42.

In an exemplary embodiment of the present invention, the VM server 4 is a computer in which “Xen (registered trademark)” operates as a Virtual Machine Monitor (VMM). At this time, the control VM 41 is a VM called a domain 0.

In another exemplary embodiment of the present invention, the VM server 4 is a computer in which “VMware (registered trademark) ESX Server” operates as a virtual machine monitor. At this time, the control VM 41 is a VM called a Service Console.

The storage unit 42 is a physical storage unit connected to the VM server 4. The storage unit 42 stores VM images 421 received by a VM image receiving section 411. The VM image 421 stored in the storage unit 42 has a one-to-one correspondence with the VA instance 43.

In an exemplary embodiment of the present invention, the storage unit 42 is a hard disk unit incorporated in the VM server 4.

In another exemplary embodiment of the present invention, the storage unit 42 is a shared-type storage unit connected to a plurality of VM servers 4 through a Storage Area Network (SAN) such as a Fibre Channel or “iSCSI”.

In still another exemplary embodiment of the present invention, the storage unit 42 is a network-connection-type storage unit (Network Attached Storage: NAS) connected to a Local Area Network (LAN) such as Ethernet (registered trademark).

The VA instance 43 is one of VMs operating on the VM server 4. The VA instance 43 includes the setting control section 44. A server program 45 operates on the VA instance 43. Also, the VA instance 43 is connected to the virtual storage unit 46. Although the virtual storage unit 46 and the VM image 421 are a same entity, a difference is in that what is viewed from the control VM 41 is the VM image 421 and what is viewed from the VA instance 43 is the virtual storage unit 46.

The virtual storage unit 46 stores self-identification data 461, a setting file template 462, and a server program setting file 463.

The self-identification data 461 includes a VA instance ID (identifier) for identifying the VA instance 43 and a data for identifying the configuration data DB 2 of a connection destination. The setting file template 462 is a file serving as a base of the server program setting file 463. Here, the setting file template 462 is a template of the server program setting file 463. The server program setting file 463 is a setting file defining the operation of the server program 45.

The setting control section 44 is a program for generating the server program setting file 463 based on the setting file template 462 stored in the virtual storage unit 46 and the data stored in the configuration data DB 2. This program is recorded as a part of the VM images 421. That is, the setting control section 44 is included in the VM images 421.

The server program 45 is a program for providing some service to a system user. The behavior of the server program 45 depends on the contents of the server program setting file 463. That is, the server program 45 controls the computer to operate according to the contents of the server program setting file 463.

In an exemplary embodiment of the present invention, the server program 45 is a program providing a blog service. For its own operation, the server program 45 requires a connection to an external database server. Therefore, a data of the database server of the connection destination (such as a host name) is required to be specified in the server program setting file 463.

The VM server 4 having the above-described configuration generally operates as follows.

The VM image receiving section 411 receives a VM image sent from the virtual appliance control apparatus 1, and stores the received VM image in the storage unit. Next, The VM receiving section 411 starts the VA instance 43 in accordance with a VM start operation by a system manager. The setting control section 44 included in the VA instance 43 uses a resource data solving section 441 and a setting updating section 442 to refer to the configuration data DB 2 and the setting file template 462, so as to generate the server program setting file 463. Finally, the setting control section 44 uses an update notifying section 443 to notify a setting change to the server program 45 operating on the VA instance 43, so as to validate the change.

### <Name Server 5>

The name server 5 has a role of performing transformation between a host name and an IP address for the portal Web server 6 and each VA instance 43. That is, the name server 5 is a server for performing name solution. As an example of the name server 5, a DNS server (Domain Name Server) and a route server are assumed. It should be noted that the name server is not restricted to these examples.

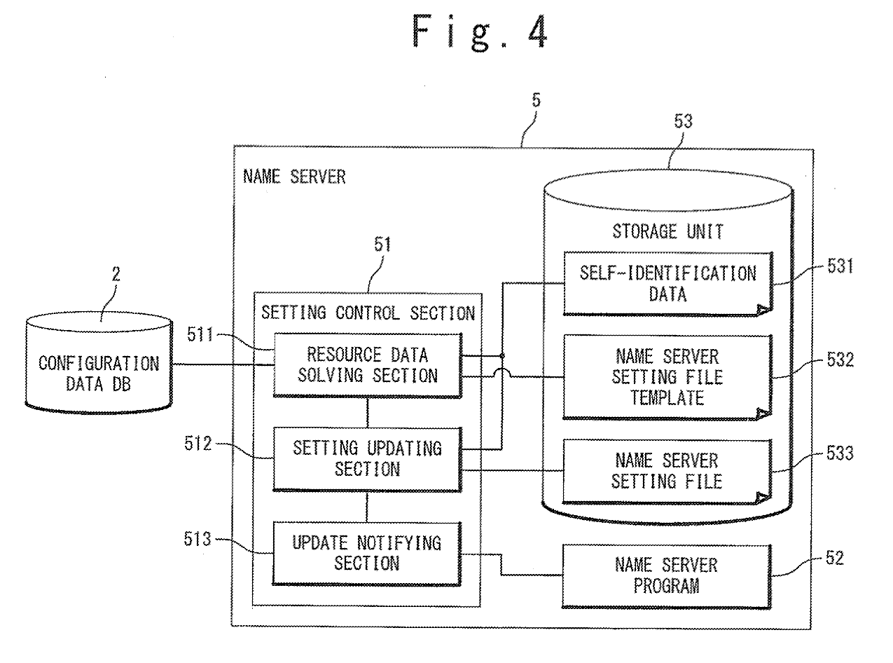

Referring to FIG. 4, the internal configuration of the name server 5 will be described.

The name server 5 includes a setting control section 51, a name server program 52, and a storage unit 53.

The setting control section 51 is a portion having functions similar to those of the setting control section 44 included in the VA instance 43. The setting control section 51 includes a resource data solving section 511, a setting updating section 512, and an update notifying section 513.

A name server program 52 is a program for providing a service of transformation from a host name to an IP address and transformation from an IP address to a host name. A correspondence table of host names and IP addresses required for this transformation is described as a part of a name server setting file 533.

The storage unit 53 is a storage such as a hard disk connected to the name server 5. The storage unit 53 includes self-identification data 531, a name server setting file template 532, and a name server setting file 533.

The name server 5 having the above-described configuration generally operates as follows.

The setting control section 51 uses the resource data solving section 511 to periodically refer to the configuration data DB 2, and generates the contents of a name server setting file from the reference result and the name server setting file template 532. Then, when the contents of the setting file as a generation result, and the contents of the existing name server setting file 533 differ from each other, the setting control section 51 uses the setting updating section 512 to replace the contents of the existing name server setting file 533 by the contents of the setting file as the generation result. In this case, the setting control section 51 uses the update notifying section 513 to notify a setting change to the name server program 52, so as to validate the setting change.

### <Portal Web Server 6>

The portal Web server 6 is a Web server as an entrance when the user terminal 7 uses a service provided by the VA instance. The portal Web server 6 returns a list of services available on the VA instance to the user terminal 7 upon receiving a service menu acquiring request from the user terminal 7.

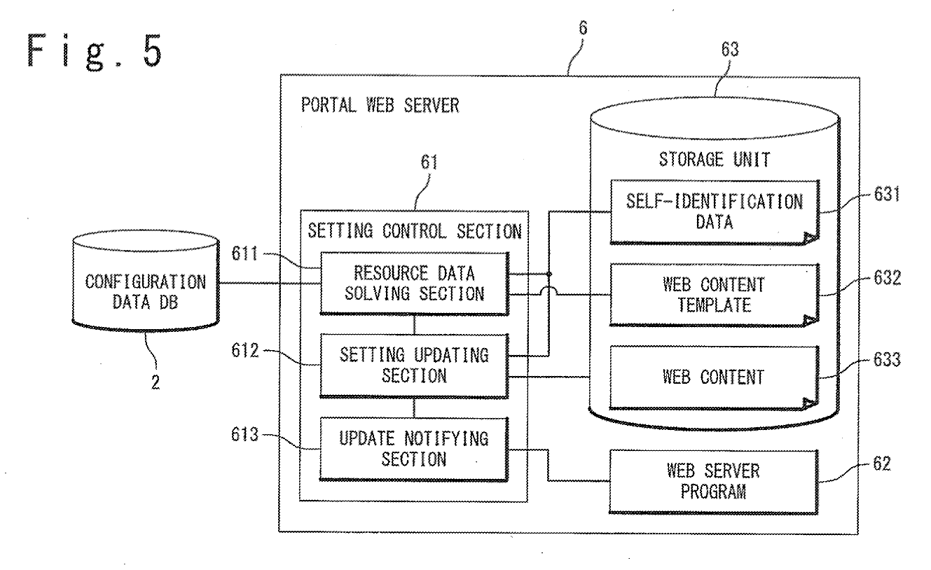

Referring to FIG. 5, the internal configuration of the portal Web server 6 will be described. The portal Web server 6 includes a setting control section 61, a Web server program 62, and a storage unit 63.

The setting control section 61 is a portion having functions similar to those of the setting control section 44 included in the VA instance 43 and those of the setting control section 51 included in the name server 5. The setting control section 61 includes a resource data solving section 611, a setting updating section 612, and an update notifying section 613.

The Web server program 62 is a program for providing a service of returning a corresponding document file to a page acquiring request (including the service menu acquiring request) from the user terminal 7. The Web server program 62 has a function of acquiring the document file corresponding to a page name included in the page acquiring request from Web contents 633, which will be described further below, and returning the document file to the user terminal 7 as a request source.

The storage unit 63 is a storage unit such as a hard disk connected to the portal Web server 6. The storage unit 63 stores self-identification data 631, a Web contents template 632, and the Web contents 633.

In an exemplary embodiment of the present invention, the HTTP protocol (HyperText Transfer Protocol) is used for a page acquiring request and its response. A URL (Uniform Resource Locator) is used for specifying a page to be obtained. A HTML language (HyperText Markup Language) is used as the format of the document file.

The portal Web server 6 having the above-described configuration generally operates as follows.

The setting control section 61 uses the resource data solving section 611 to refer to the configuration data DB 2 periodically and generates the Web contents from the result and the Web contents template 631. Then, when the details of the Web contents as generation results and the details of the existing Web contents 633 differ from each other, the setting control section 61 uses the setting updating section 612 to replace the details of the existing Web contents 633 by the details of the Web contents as the generation results. In this case, the setting control section 61 uses the update notifying section 613 to notify a setting change to the Web server program 62 so as to validate the change.

### <User Terminals 7>

The user terminal 7 is a terminal for a user (an end user) of the virtual appliance deploying system of the present invention. The user terminal 7 includes an input unit such as a keyboard or a mouse, and an output unit such as a display, and also has a function of issuing a page acquiring request to the portal Web server 6 and the VA instance 43 through a network. Here, there are a plurality of the user terminals 7.

According to an exemplary embodiment of the present invention, each user terminal 7 is a PC (personal computer) on which a Web browser operates. The Web browser has a function of requesting the Web server to obtain a page specified by a URL by using an HTTP protocol and shaping the resultant HTML document for display.

### <Administrator Terminal 8>

The manager terminal 8 is a terminal for a manager of the virtual appliance deploying system of the present invention. The manager terminal 8 includes input/output units, and also a function of operating the virtual appliance control apparatus 1 through a network.

According to an exemplary embodiment of the present invention, the manager terminal 8 is a personal computer on which the Web browser operates. The Web browser has a function of requesting the Web server to obtain a page specified by a URL by using an HTTP protocol and shaping the resultant HTML document for display.

### <Overall Operation Procedure: Use of Virtual Appliance by User>

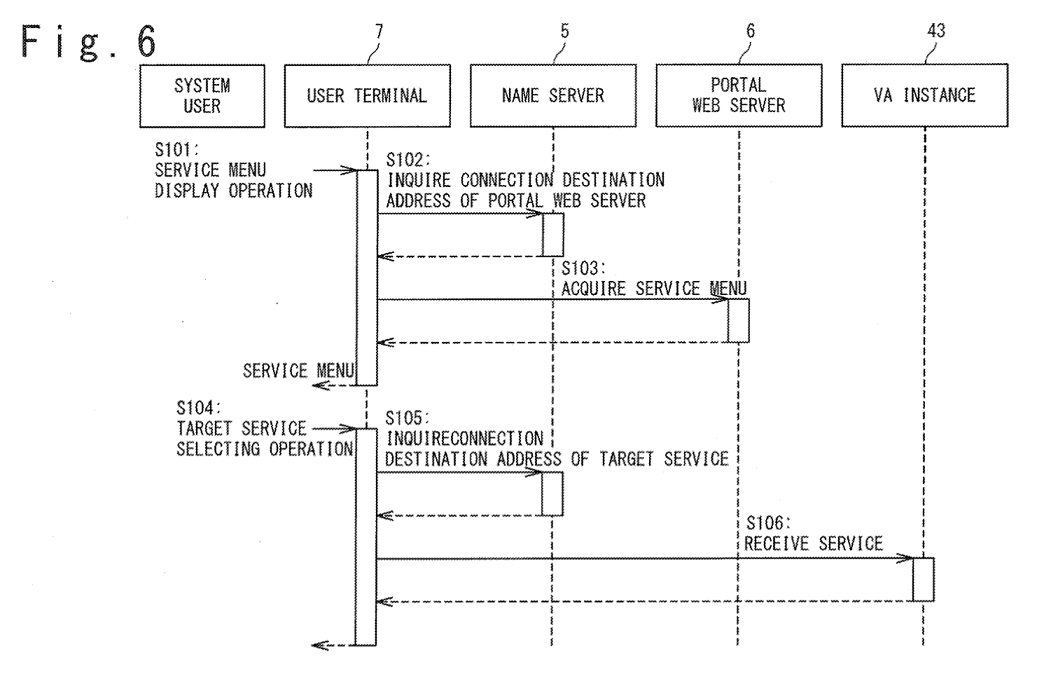

Referring to a sequence diagram of FIG. 6, the operation procedure when an introduced virtual appliance is used from a user of the virtual appliance deploying system of the present invention will be described.

### (1) Step S101

The user of the virtual appliance deploying system of the present invention performs a service menu displaying operation on the user terminal 7.

### (2) Step S102

The user terminal 7 transfer a host name of the portal Web server 6 to the name server 5 to inquire a connection destination address of the portal Web server 6. The host name of the portal Web server 6 has been stored in advance in the user terminal 7.

### (3) Step S103

The user terminal 7 uses the connection destination address obtained from the name server 5 to connect to the portal Web server 6 and issues a service menu acquiring request. As a result, the user terminal 7 displays the acquired service menu and waits for an operation from the user.

### (4) Step S104

The user performs an operation of viewing the service menu displayed on the user terminal 7 and selecting a target service.

### (5) Step S105

The user terminal 7 transfers a host name of a VA instance corresponding to the service selected by the user to the name server 5 to inquire a connection destination address of the selected service.

### (6) Step S106

The user terminal 7 sends a request for receiving the service to the VA instance providing the target service.

Depending on the type of service provided on the VA instance, there is a possibility of performing a plurality of pairs of request-response (hereinafter, roundtrips) between the user terminal 7 and the VA instance. In this case, the above-described operations from step S104 to step S106 are repeated. However, details of the second roundtrip and the subsequent are different from those of the first roundtrip in the following point.

In the second roundtrip and the subsequent, at the step S104, a display on the user terminal 7 shows a progress of the target service. The operation by the user is one of operations selectable in the progress of the service.

In the second roundtrip and the subsequent, the user terminal 7 stores the details of past inquiries to the name server 5 and the inquiry results. Therefore, step S105 is omitted.

### <Overall Operation Procedure: Operation of Virtual Appliance Deploying System 1 by Manager>

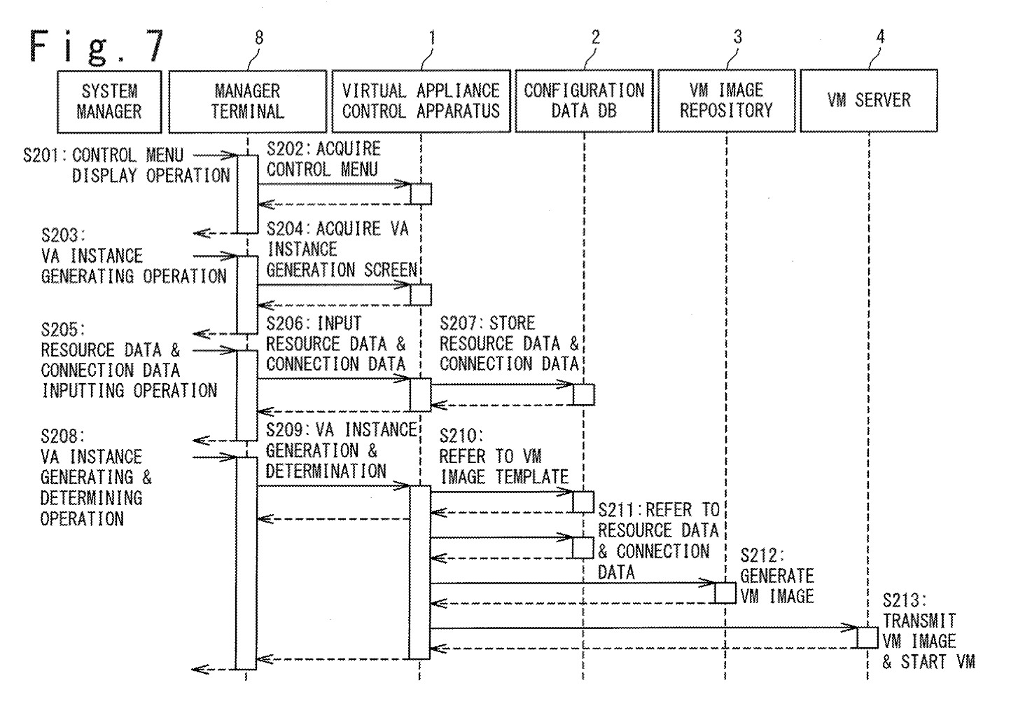

Referring to a sequence diagram of FIG. 7, the operation procedure when a new VA instance is generated by the manager of the virtual appliance deploying system of the present invention will be described.

### (1) Step S201

The manager performs an operation on the manager terminal 8 for calling a management menu.

### (2) Step S202

The manager terminal 8 issues a management menu acquiring request to the virtual appliance control apparatus 1. The manager terminal 8 receives the management menu from the virtual appliance control apparatus 1 in response to the request, and displays the details of the management menu. The management menu includes a VA instance generating operation as an option. For example, the manager terminal 8 displays a button for a VA instance generating operation on the management menu.

### (3) Step S203

The manager operates the management menu on the manager terminal 8 so as to execute a VA instance generating operation.

### (4) Step S204

The manager terminal 8 issues a request for acquiring display data for a VA instance generation screen to the virtual appliance control apparatus 1. The manager terminal 8 receives the display data for the VA instance generation screen in response to the request, and displays the VA instance generation screen based on the received data. The VA instance generation screen includes an input region of resource data and an input region of data about connection among VA instances.

### (5) Step S205

The manager inputs data of resources assigned to a new VA instance and connection data among VA instances on the VA instance generation screen display on the manager terminal 8.

### (6) Step S206

The manager terminal 8 transmits the inputted resource data and connection data to the virtual appliance control apparatus 1.

### (7) Step S207

The virtual appliance control apparatus 1 receives the resource data and the connection data from the manager terminal 8, and stores the received resource data and connection data in the configuration data DB 2. Upon completion of this step, the manager terminal 8 displays a button for an operation of determining VA instance generation.

### (8) Step S208

The manager executes an operation of determining VA instance generation on the manager terminal 8. Here, the manager operates the button for the operation of determining VA instance generation.

### (9) Step S209

The manager terminal 8 notifies determination of VA instance generation to the virtual appliance control apparatus 1.

### (10) Step S210

The virtual appliance control apparatus 1 refers to a VM image template corresponding to a VM image, stored in the VM image repository 3, for a new VA instance to be generated.

### (11) Step S211

The virtual appliance control apparatus 1 refers to the configuration data DB 2 to acquire the resource data of the new VA instance and a VA instance as the connection destination.

### (12) Step S212

The virtual appliance control apparatus 1 uses a template of the VM image in the VM image repository 3 and the resource data obtained from the configuration data DB 2 to generate a VM image for the new VA instance.

### (13) Step S213

After transmitting the generated VM image to a VM server 4 on which the new VA instance operates, the virtual appliance control apparatus 1 requests the VM server 4 to start a VM corresponding to the transmitted VM image.

Next, a more detailed operation procedure of each of the components of the virtual appliance deploying system according to the present invention, that is, the virtual appliance control apparatus 1, the VM servers 4, the name server 5, and the portal Web server 6 will be described.

### <Operation Procedure of Virtual Appliance Control Apparatus 1>

Hereinafter, models of the resource data and the connection data of the VA instance in the virtual appliance control apparatus 1 will be described, and then a detailed operation procedure of each unit included in the virtual appliance control apparatus 1 will be described.

### <Models of Resource Data and Connection Data>

The virtual appliance control apparatus 1 manages resources assigned to each VA instance and a connecting relation among the VA instances as a set of pairs of an attribute name and a value.

Although depending on the type of VA, attribute names included in this set typically include the following attributes:

(1) Package name

(2) Package instance number

(3) Role name

(4) VA instance number

(5) Host name

(6) IP address (Internet Protocol address)

(7) MAC address (Media Access Control address)

(8) UUID (Universally Unique Identifier)

Four attributes of a package name, a package instance number, a role name, and a VA instance number are attributes for uniquely identifying a VA instance. Also, these four attributes are essential attributes required to be defined for all VA instances.

The package name is a name for identifying a VA package configured of a plurality of VAs. The package instance number is a number for identifying an individual VA package instance generated based on the same VA package when the VA packages are deployed on the VM servers 4 as VA package instances. The role name is a name for identifying an individual VA belonging to a single VA package. The VA instance number is a number for identifying a VA instance having the same role name in a single VA package instance.

Combinations of the above-described four essential attributes are called as follows.

(1) VA instance ID: is a group of the package name, the package instance number, the role name, and the VA instance number, and is used for uniquely identifying a VA instance.
(2) VA ID: is a pair of the package name and the role name, and is used for uniquely identifying a VA.
(3) VA package instance ID: is a pair of the package name and the package instance number, and is used for uniquely identifying a VA package instance.

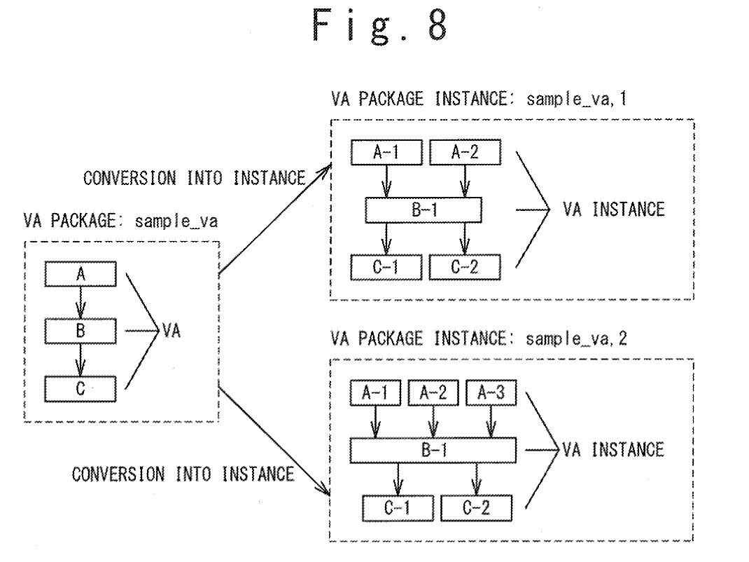

Here, referring to FIG. 8, specific examples of these essential attributes will be described.

In FIG. 8, there is a VA package having a package name of “sample_va”. This VA package contains VAs having role names of “Web”, “Logic”, and “Data”.

By using VA IDs, these VAs can be identified as follows:

{sample_va, Web}

{sample_va, Logic}

{sample_va, Data}

FIG. 8 contains two VA package instances generated based on the VA package “sample_va”. These VA package instances are assigned with package instance numbers of “1” and “2”, respectively.

By using VA package instance IDs, these VA package instances can be each identified as follows:

{sample_va, 1}

{sample_va, 2}

Moreover, a single VA package instance may contain a plurality of VA instances generated based on a single VA. In FIG. 8, the VA package instance of “{sample_va, 1}” contains two instances for the VA of “{sample_va, Web}”.

By using VA instance IDs, these VA instances can be each identified as follows:

{sample_va, 1, Web, 1}

{sample_va, 1, Web, 2}

### <Operation Procedure of Virtual Appliance Control Apparatus 1/Operation Section 11>

A role of the operation section 11 is to transmit display data for a management screen to the manager terminal 8, and to receive a request from the manager terminal 8 and transfer the request to an appropriate unit.

The management screen to be transmitted to the manager terminal 8 by the operation section 11 include of the following types:

(1) Management menu screen

(2) VA package search screen

(3) VA instance generation screen

(4) VA instance deployment screen

The display data for the management menu screen is first transmitted when the manager terminal 8 connects to the virtual appliance control apparatus 1 and the management menu screen displays a list of control operations executable on the virtual appliance control apparatus 1.

The VA package search screen displays a list of VA packages stored in the VM image repository 3 based on a keyword inputted by the system manager and also provides an operation of selecting one of them for generation of an instance.

The VA instance generation screen is a screen for the system manager to input the resource data and the connection data for the VA package selected by the system manager.

The VA instance deployment screen is a screen for the system manager to instruct generation of a VM image and transmission of the VM image to the VM server for the VA package instance selected by the system manager.

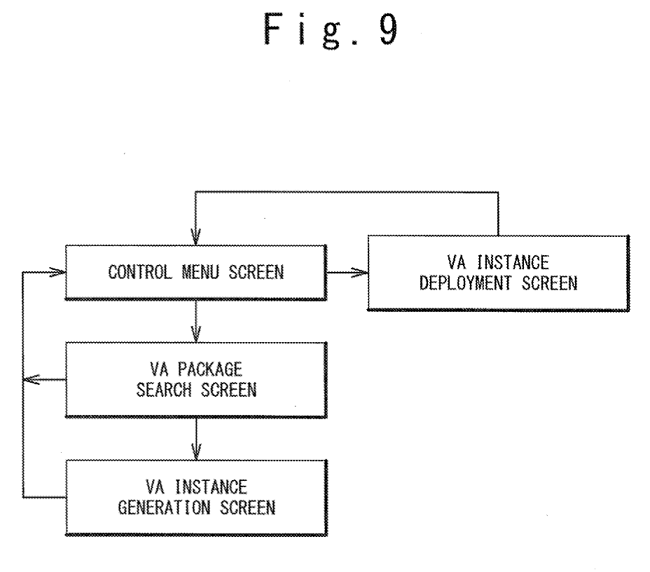

Referring to a state transition diagram of FIG. 9, a relation among these screens will be described.

In FIG. 9, four screens are shown, that is, “management menu screen”, “VA package search screen”, “VA instance generation screen”, and “VA instance deployment screen”. As buttons for executable control operations, the management menu screen contains a button for VA package search and a button for VA instance deployment. When the system manager operates the button for VA package search, a transition to the VA package search screen is made. Also, when the system manager operates the button for VA instance deployment, a transition to the VA instance deployment screen is made. In the VA package search screen, when the manager selects a specific VA package and operates the button for operation of VA instance generation, a transition to the VA instance generation screen is made. A transition can be made to the management menu screen from any of the VA package search screen, the VA instance generating display, and the VA instance deployment screen.

According to an exemplary embodiment of the present invention, the operation section 11 is a Web server program. The manager terminal 8 transmits an HTTP request including an URL for identifying a management screen to the operation section 11. The operation unit 11 transmits an HTML document containing details of the screen in response to this HTTP request. The manager terminal 8 transmits the data inputted by the system manager to the operation section 11 as a part of the HTTP request.

### <Virtual Appliance Control Apparatus 1/Operation Section 11/VA Package Search Screen>

The VA package search screen contains a button for inputting the part or entire of a package name to be searched for a VA package, a button for instructing the instance generation for the VA package selected by the system manager, and a button for returning to the management menu screen. By searching the VM image repository 3 for data of the stored VA package and a VA, the virtual appliance control apparatus 1 executes a process of searching a VA package. When the system manager operates the button for instructing the instance generation for the VA package, a transition to the VA instance generation screen is made. Also, when the system manager operates the button for returning to the management menu screen, a transition to the management menu screen is made.

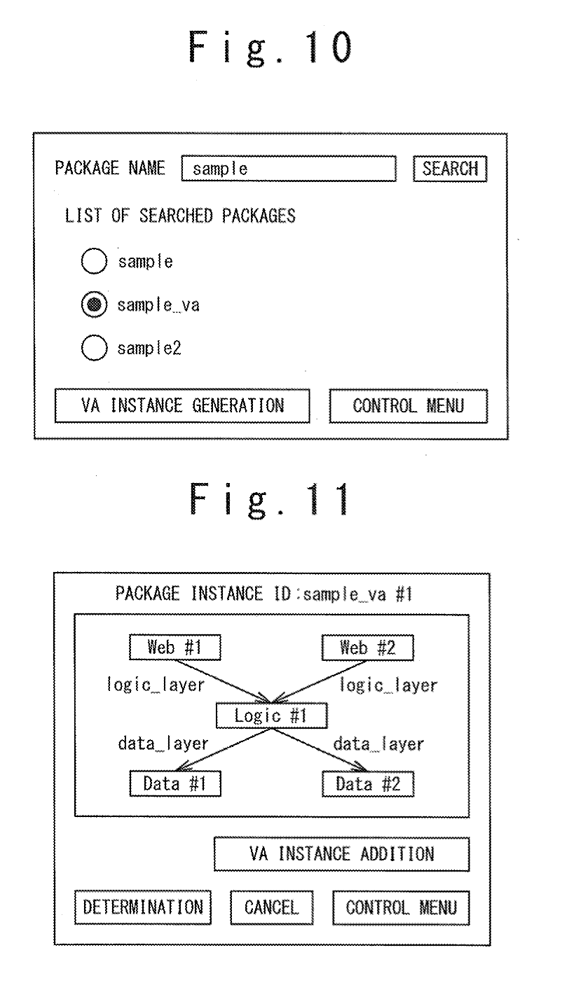

Referring to FIG. 10, the configuration of the VA package search screen in an exemplary embodiment of the present invention will be described.

Referring to FIG. 10, the VA package search screen has three buttons, that is, a “search button”, a “VA instance generation button”, and a “management menu”. Also, a box for inputting a VA package name is present on an upper portion of this screen. The system manager inputs the entire or part of a package name to a box for inputting a VA package name as a keyword, and then operates the search button. Then, the manager terminal 8 issues the HTTP request to the virtual appliance control apparatus 1. At this time, the screen to be obtained is the VA package search screen and the keyword inputted by the system manager is included as a search character string (query string) of an URL.

In the present exemplary embodiment, when the VA package search screen is called adding the keyword for search, the virtual appliance control apparatus 1 uses the VA package searching section 12 to search a VA package containing the keyword as a part of the package name, and then displays a VA package list as the search result. When the system manager selects one of candidates in the VA package list and operates a determination button, the manager terminal 8 issues the HTTP request to the virtual appliance control apparatus 1. At this time, the screen to be obtained is the VA instance generation screen and, the package name selected by the system manager is included as a search character string of an URL.

### <Virtual Appliance Control Apparatus 1/Operation Section 11/VA Instance Generation Screen>

As for a VA package instance to be newly generated, the VA instance generation screen contains resource data for VA instances included therein, a button for inputting a connection relation among these VA instances, and a button for returning to the management menu screen.

In the VA instance generation screen, when the system manager inputs resource data and connection data for a VA instance, the operation section 11 stores the resource data and connection data inputted by the manager in the configuration data DB 2 and also stores data of a non-deployed VA package instance as an internal state of the virtual appliance control apparatus 1.

In the VA instance generation screen, when system manager selects a return to the management menu screen, a transition to the management menu screen is made.

Referring to FIG. 11, the configuration of the VA instance generation screen in an exemplary embodiment of the present invention will be described.

This screen contains a VA package instance ID assigned to a VA package instance in the course of generation and a set of VA instances of that VA package instance. Each VA instance is represented as a button, and has a role name and a VA instance number written on its label. When the system manager operates a button corresponding to each VA instance, an attribute list of that VA instance is displayed, to allow attribute values to be inputted. Moreover, a connecting relation among the VA instances is represented as an arrow directed from a VA instance of a connection source to a VA instance of a connection destination. A connection name is displayed on a label of the arrow. By changing an endpoint of this arrow, the system manager can change the connecting relation among the VA instances.

The VA instance generation screen depicted in FIG. 11 contains a button of “VA instance addition”. The VA instance addition button has an effect of adding a new VA instance to the VA package instance in the course of generation. Here, what can be added is restricted to an instance of a VA contained in the VA package to which the VA instance in the course of generation belongs.

Moreover, the VA instance generation screen depicted in FIG. 11 further contains three buttons, that is, a “determination button”, a “cancel button”, and a “management menu button”. When the determination button is operated, the operation section 11 determines the details of the VA package instance in the course of generation, and registers the details in the configuration data DB 2. When the cancel button is operated, the operation section 11 discards the details of the VA package instance in the course of generation. When the management menu button is operated, the screen returns to the management menu screen. The management menu button is operated without operation of the determination button after any one of an operation of generating a VA instance, an operation of inputting resource data, and an operation of inputting connection data. At this time, the operation section 11 displays a screen in which confirmation of a transition to the management menu screen is questioned. Here, when the system manager operates a confirmation button while the screen questioning of confirmation is being displayed, the operation section 11 discards the details of the VA package instance in the course of generation and makes a transition to the management menu screen.

### <Virtual Appliance Control Apparatus 1/Operation Section 11/VA Instance Deployment Screen>

The VA instance deployment screen allows an operation of displaying a list of (non-deployed) VA package instances not yet deployed on the VM servers 4 among VA package instances generated through the VA instance generation screen and deploying the non-deployed VA package instances, an operation of discarding the non-deployed VA package instances, and an operation of returning to the management menu screen.

In the VA instance deployment screen, when the system manager selects an operation of deploying a VA package instance, the operation section 11 uses the VM image generating section 15 and the VM image transmitting section 16 to execute a process of deploying the generated VA package instance. This process corresponds to step S209 to step S213 in the sequence diagram of FIG. 7.

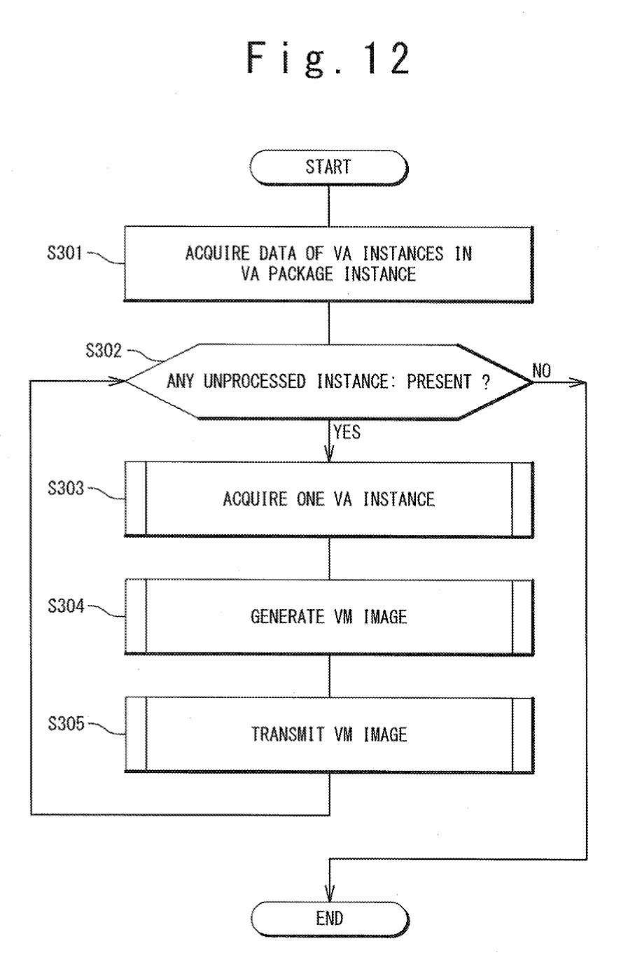

Referring to a flowchart of FIG. 12, the operation procedure of the operation section 11 when an operation for deploying a VA package instance is performed on the VA instance deployment screen will be described.

### (1) Step S301

The operation section 11 refers to the configuration data DB 2 to obtain data of all of VA instances included in the selected VA package instance.

### (2) Step S302

The operation section 11 refers to the obtained data of the VA instances to check whether any unprocessed VA instance is present. If all the VA instances have been processed, the operation section 11 ends the VA package instance deploying process.

### (3) Step S303

If any unprocessed VA instance is present, the operation section 11 takes out anyone of the unprocessed VA instances.

### (4) Step S304

The operation section 11 uses the VM image generating section 15 to generate a VM image for the taken-out VA instance.

### (5) Step S305

The operation section 11 uses the VM image transmitting section 16 to transmit the generated VM image to the VM server 4. It should be noted that after this process ends, the operation section 11 repeats a similar process until no unprocessed VA instance is present.

In the VA instance deployment screen, when the system manager performs an operation of discarding a VA package instance, the operation section 11 deletes data of the concerned VA package instance from the configuration data DB 2. When the system manager performs an operation of returning to the management menu screen, a transition to the management menu screen is made.

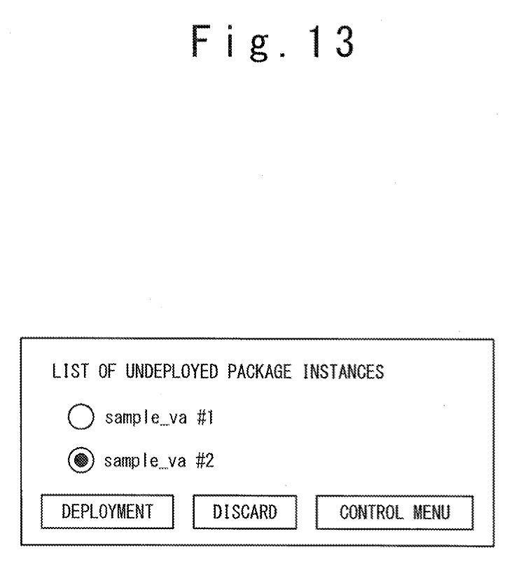

Referring to FIG. 13, the configuration of the VA instance deployment screen in an exemplary embodiment of the present invention will be described.

This screen contains, in addition to a list of non-deployed VA package instances, a “deployment execution button”, a “discard button”, and a “management menu button”. When the deployment execution button is operated for a specific VA package instance being selected, the operation section 11 executes a process of deploying the VA package instance. When the discard button is operated for a specific VA package instance being selected, the operation section 11 deletes data of the concerned VA instance in the configuration data DB 2. When the management menu button is operated, the operation section 11 makes a transition to the management menu screen.

<Operation Procedure of Virtual Appliance Control Apparatus 1/Resource data Storage Section 12>

The resource data storage section 12 has a function of registering resource data inputted from the manager terminal 8 via the operation section 11 in the connection data DB 2. This process corresponds to step S207 in the sequence diagram of FIG. 7.

The resource data storage section 12 receives resource data of at least one VA instance, and stores the resource data in the configuration data DB 2.

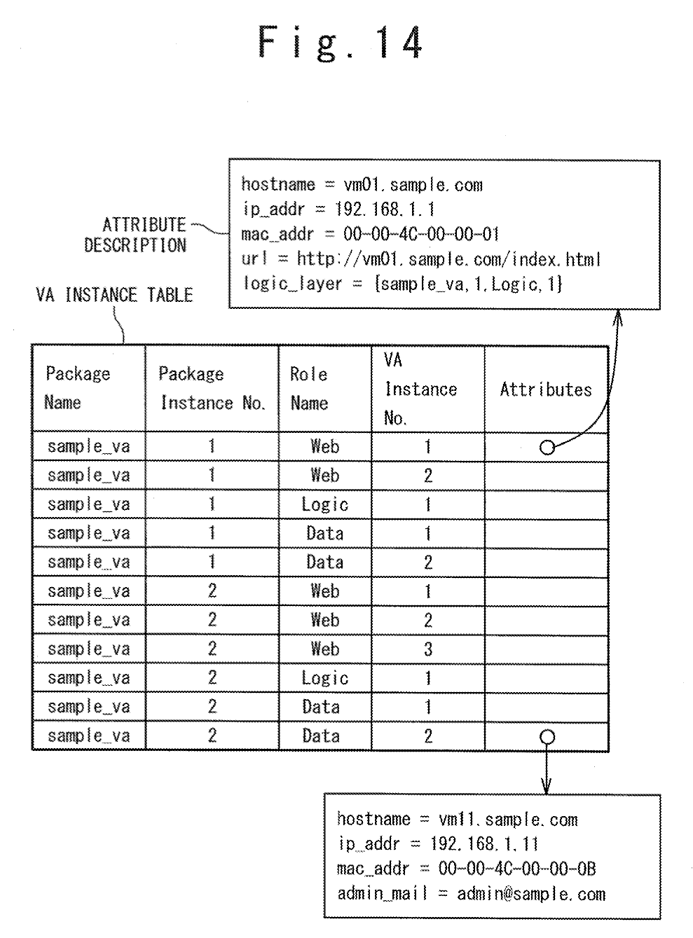

Here, referring to FIG. 14, an example of a storage format of the resource data will be described.

In this example, attribute data of a VA instance deployed on the VM server 4 is stored in each row of a table called a VA instance table. A reference to external attribute description of “Attributes” is stored in each row of the table, in addition to the elements of the VA instance ID such as a VA package name of “Package Name”, a VA package number of “Package Instance No.”, a VA role name of “Role Name”, and a VA instance number of “VA instance No.”. In the attribute description referred to based on the stored reference to attribute description of “Attributes”, a pair of an attribute name and an attribute value is described for each of the attributes of the VA instances other than the VA instance ID.

In the example of FIG. 14, the VA instance table can be realized as a table in a general relational database. Also, the attribute description of an individual VA instance is stored as a text file, and a name of that text file can be stored in the reference to attribute description of “Attributes” in the VA instance table.

It should be noted that a storage format of resource data shown herein is merely an example and the present invention is not restricted to this example.

### <Operation Procedure of Virtual Appliance Control Apparatus 1/Connection Data Storage Section 13>

The connection data storage section 13 has a function of registering connection data inputted from the manager terminal 8 via the operation section 11 in the configuration data DB 2. This process corresponds to step S207 in the sequence diagram of FIG. 7.

The connection data storage section 13 receives the following data:

(1) VA instance ID indicating a VA instance of a connection source,

(2) Connection name, and

(3) VA instance ID indicating a VA instance of a connection destination.

Among these, the VA instance IDs of the connection source and the connection destination are represented by four elements, that is, a package name, a package number, a role name, and a VA instance number. The connection name has a meaning of specifying the type of connection for the VA instance of the connection source.

For the above input, the connection data storage section 13 adds a pair of the connection name and the VA instance ID of the connection destination to data corresponding to the VA instance as the connection source and stored in the configuration data DB 2.

Here, an example of a storage format of connection data will be described with reference to FIG. 14.

In FIG. 14, connection data is stored in a format similar to that of resource data. That is, attributes of the connection data together with attributes of the resource data are stored in an attribute description “Attributes” of the VA instance as the connection source.

On the first row of the VA instance table of FIG. 14, the attribute description contains a pair of:

a connection name called “logic_layer”, and

a VA instance ID {sample_va, 1, Logic, 1} of a connection destination.

The VA instance ID of the connection destination herein means a VA instance relevant to the following attributes:

(1) Package name=sample_va

(2) Package instance number=1

(3) Role name=Logic

(4) VA instance number=1.

This corresponds to a VA instance on the third row in the VA instance table.

<Operation Procedure of Virtual Appliance Control Apparatus 1/VM Image Generating section 14>

The VM image generating section 14 has a function of generating a VM image corresponding to a VA instance to be deployed, as a part of a process of deploying the VA instance. This process corresponds to step 5210 to step 5212 in the sequence diagram of FIG. 7.

The VM image generating section 14 receives a VA instance ID, and generates a VM image for executing a VA instance specified by that VA instance ID.

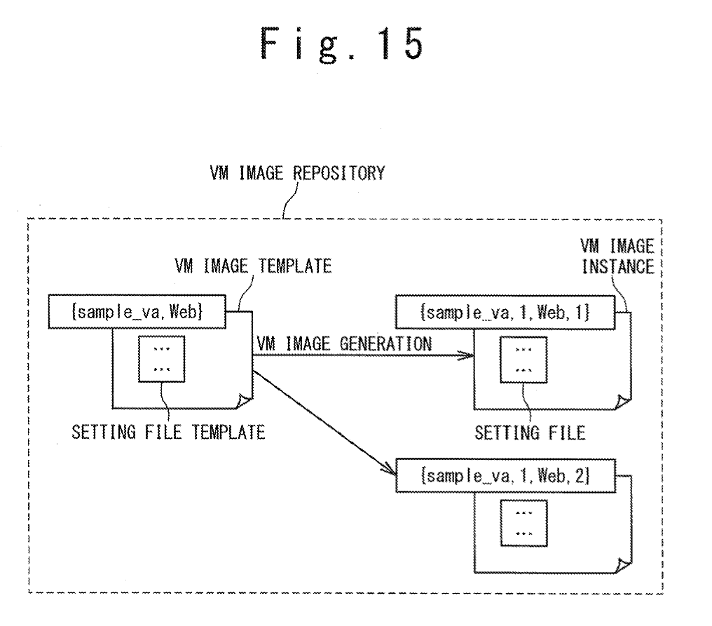

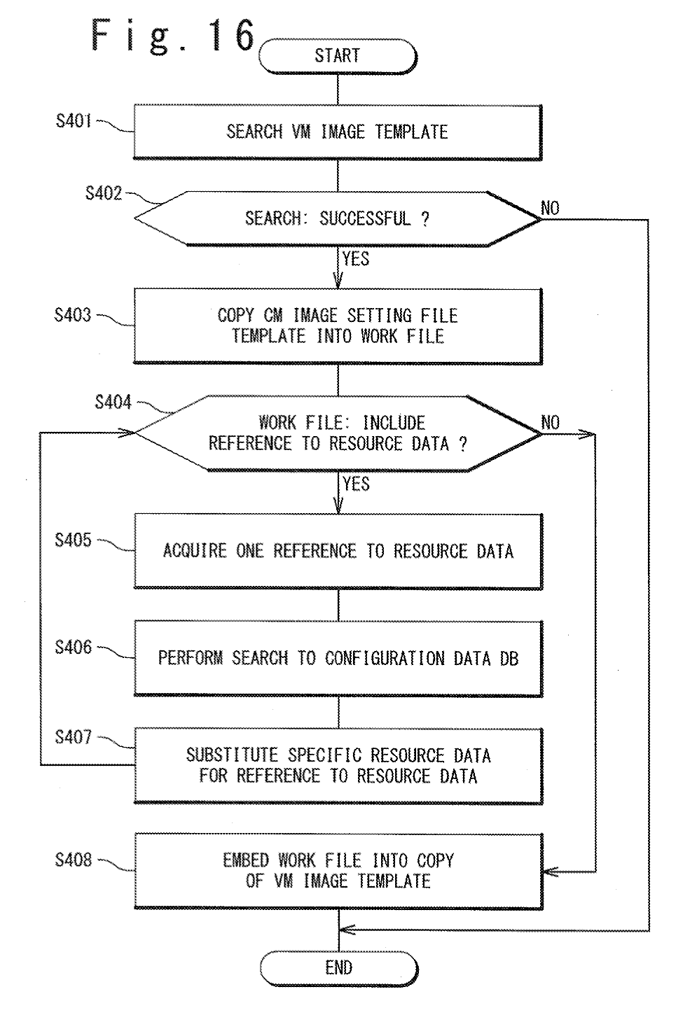

First, referring to FIG. 15, types of VM images stored in the VM image repository 3 will be described.

The VM image repository 3 stores two types of VM images, that is, a “VM image instance” and a “VM image template”.

The VM image instance is a VM image for starting a specific VA instance. The VA instance ID identical to that of a corresponding VA instance is added to the individual VM image instance. Also, the VM image instance includes, as its part, one or more setting files containing data depending on the specific VA instance.

As an example of the setting file included in the VM image instance, there is a file in which a host name and an IP address assigned to a VA instance are described. Such a setting file can be described as a file separate from the VM image itself or can be embedded in a VM image. Which format the setting file employs does not substantially influence the present invention.

The VM image template is a VM image serving as a base of a VM image instance when the VM image instance is generated. The VM image template is stored in correspondence to “a pair of a specific VA package and a role name”. Therefore, the individual VM image template is identified by the pair of the VA package name and the role name. The VM image template includes, as its part, at least one file called a setting file template. The setting file template is a file serving as a base of the setting file when the setting file is generated in the VM image instance.

In the present exemplary embodiment, it is assumed that the VM image template is stored in advance in the VM image repository 3.

In the following, referring to a flowchart of FIG. 16, the operation procedure of the VM image generating section 14 will be described.

### (1) Step S401

The VM image generating section 14 searches the VM image repository 3 by using a VM image template ID as a key, to retrieve a concerned VM image template.

### (2) Step S402

The VM image generating section 14 continues the control flow if the search has been successful, and ends the control flow if the search has failed. It should be noted that if the VM image generating section 14 has failed to search, the VM image generating process fails.

### (3) Step S403

The VM image generating section 14 copies (duplicates) a setting file template included in the retrieved VM image template into a work file. The work file means a file temporarily generated in the virtual appliance control apparatus 1.

### (4) Step S404

The VM image generating section 14 determines whether the generated work file includes a reference to resource data. Here, when the reference to resource data is included, the VM image generating section 14 goes to step 405. When a reference to resource data is not included, the control flow image advances to step S408. It should be note that the reference to resource data means a reference to a URL indicating a link to the resource data.

### (5) Step S405

When the reference to resource data is included, the VM image generating section 14 obtains a first reference to resource data from among the references to source data in the work file. Here, a reference for which substitution to specific resource data has been completed at step S407, to be described later, that is, a resolved reference, is excluded.

### (6) Step S406

The VM image generating section 14 performs a search of the configuration data DB 2 based on the obtained reference to resource data. As a result, the VM image generating section 14 can obtain a specific value of the resource data.

### (7) Step S407

The VM image generating section 14 replaces the obtained reference to resource data in the work file by the obtained value of reference data. The VM image generating section 14 then again determines whether the generated work file includes any reference to resource data, and repeats the above process until all the unresolved references are completed.

### (8) Step S408

When the generated work file does not include any reference to resource data, that is, when no unresolved reference is present, the VM image generating section 14 generates a copy of the searched VM image template, and embeds the contents of the work file in the generated copy as a setting file, so as to generate a VM image for a new VA instance. When VM image generation ends, the VM image generating section 14 completes the process.

The processes at step S406 and step S407 of FIG. 16 in which the references of resource data are replaced by specific values are called solution of resource data. In the following, a specific procedure of a process of solving resource data will be described.

In the present exemplary embodiment, it is assumed that the reference to resource data is represented in the setting file template by use of any of the following formats:

(1) VA instance ID+attribute name,

(2) Package name+role name+attribute name,

(3) Attribute name,

(4) Role name+attribute name, and

(5) Connection name+attribute name.

When the first format of “VA instance ID+attribute name” is specified, the VM image generating section 14 obtains a value of an attribute specified by an attribute name from the configuration data DB 2 for a VA instance specified by a VA instance ID, and replaces the reference to resource data by the obtained value.

When the second format of “package name+role name+attribute name” is specified, the VM image generating section 14 obtains a value of an attribute specified by an attribute name from the configuration data DB 2 for a VA instance having the specified package name and role name, and replaces the reference to resource data by the obtained value. Here, when a plurality of VA instances having the specified package name and role name are present, the VM image generating section 14 develops attribute values for all of these VA instances in the form of sequential arrangement.

When the third format of “attribute name” is specified, the VM image generating section 14 obtains a value of an attribute specified by an attribute name from the configuration data DB 2 for a VA instance as a target for a VM image generating process, and replaces the reference to resource data by the obtained value.

When the fourth format of “role name+attribute name” is specified, the VM image generating section 14 obtains a value of an attribute specified by an attribute name from the configuration data DB 2 for a VA instance belonging to the same VA package instance as a VA instance as a target for the VM image generating process and having the specified role name, and replaces the reference to resource data by the obtained value. Here, when a plurality of VA instances satisfying a condition are present, the VM image generating section 14 develops attribute values for all of these VA instances in the form of sequential arrangement.

When the fifth format of “connection name+attribute name” is specified, the VM image generating section 14 first obtains a VA instance ID, which is an attribute value for the specified connection name, for a VA instance as a target for the VM image generating process. Next, the VM image generating section 14 searches a value of the specified attribute for a VA instance specified by the VA instance ID. Through this procedure, the VM image generating section 14 reflects the resource data set for the VA instance of the connection destination on the setting file in the VA instance of the connection source.

In the second and fifth formats, an expected setting file may not be obtained only by sequentially arranging the attribute values for the plurality of VA instances. For this reason, the VM image generating section 14 repeatedly describes the configuration in the setting file template, and shapes the plurality of attribute values in an arbitrary format.

Subsequently, a specific example of a resource data solving process in an exemplary embodiment of the present invention will be described.

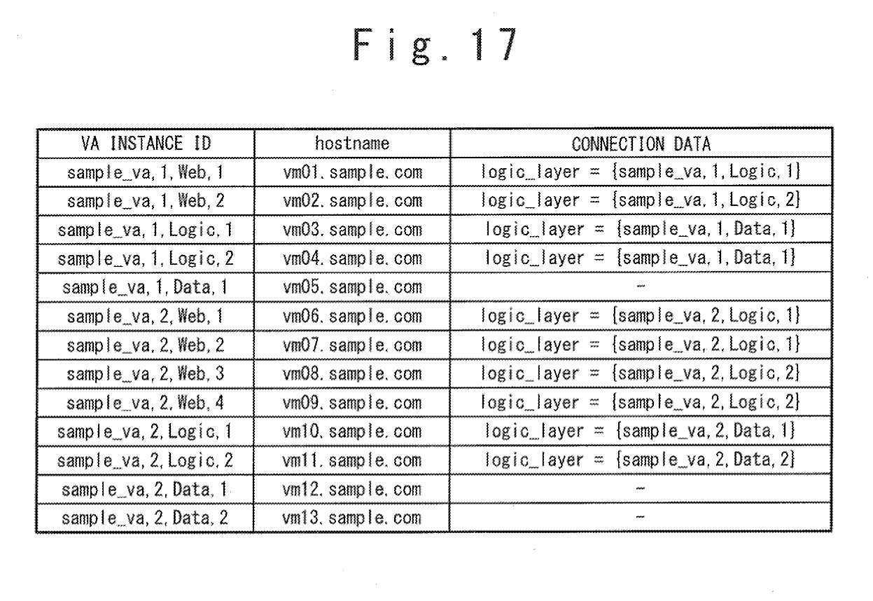

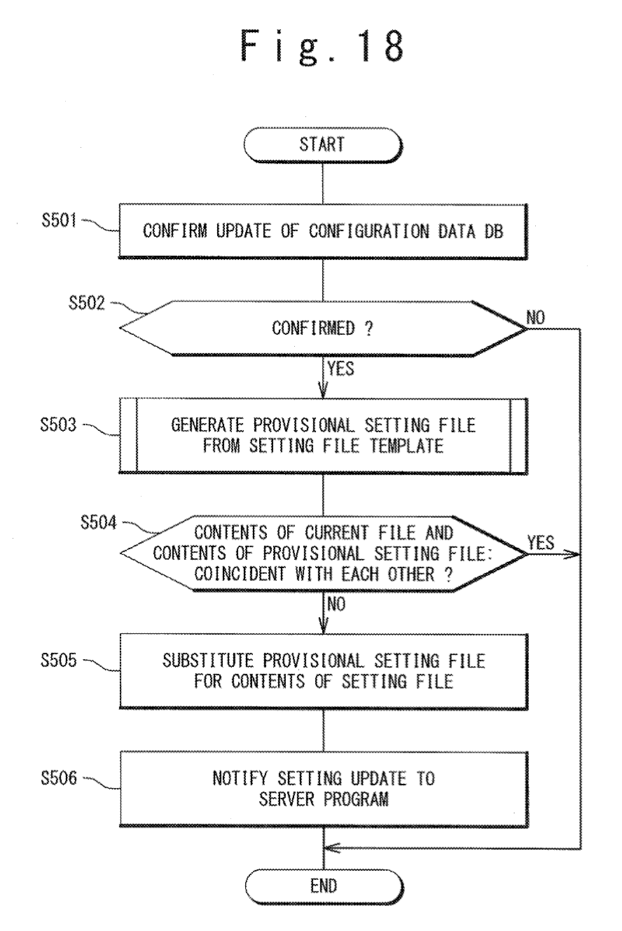

FIG. 17 shows the contents of the configuration data DB 2 in the present exemplary embodiment.

In FIG. 17, for simplification, the VA instance ID is represented as a single attribute, and only a hostname is defined as resource data for all the VA instances.

In a first example, the following is contained as a part of a template:

HostName=[% hostname %]

This corresponds to the third format of reference to the resource data. Here, when it is assumed that the VA instance as a target of the VM image generating process is:

(sample_va, 1, Web, 1),

this template segment is developed as follows:

HostName=vm01.sample.com

In a second example, the following is contained as a part of a template:

Application_Host=[% Logic/hostname %]

This corresponds to the fourth format of reference to the resource data. Here, when it is assumed that the VA instance as a target of the VM image generating process is:

{sample_va, 1, Web, 1},

this template segment is developed as follows:

Application_host=vm03.sample.com,
vm04.sample.com

In a third example, the following is contained as a part of a template:

[% FOR sample_va/Web/hostname %]

DB_Host=[% VALUE %]

[% END_FOR]

In this format, a repetition structure from “FOR” to “END_FOR” is defined, and this corresponds to the second format of reference of the resource data. In this case, evaluation is repeated in a manner such that a portion between “FOR” and “END_FOR” is developed to attribute values each obtaining the portion of “VALUE”.

The development result of this template segment is as follows:

DB_Host=vm05.sample.com

DB_Host=vm12.sample.com

DB_Host=vm13.sample.com

In a fourth example, the following is contained as a part of a template:

Backend_DB=[% data_layer/hostname %]

This corresponds to the fifth format of reference to resource data.

Here, when it is assumed that the VA instance as a target of the VM image generating process is:

{sample_va, 2, Logic, 1},

this template segment is developed as follows:

Backend_DB=vm12.sample.com

### <Operation Procedure of Virtual Appliance Control Apparatus 1/VM Image Transmitting Section 15>

The role of the VM image transmitting section 15 is to transmit a VM image instance generated by the VM image generating section 14 to a specific VM server 4. This process corresponds to step S213 in the sequence diagram of FIG. 7.

The VM image transmitting section 14 receives the following data:

(1) VA instance ID, and

(2) Host name of the VM server of a transmission destination.

The VM image transmitting section 15 obtains a VM image instance corresponding to the received VA instance ID from the VM image repository 3, and transmits it (the obtained VM image instance) to the VM server 4 specified by a host name.

### <Operation Procedure of VM Server 4>

The process of the VM server 4 is mainly divided into two, that is, “a VM image receiving process” and “a server program setting file updating process”.

The VM image receiving process is a process of receiving the VM image transmitted by the VM image transmitting section 14 of the virtual appliance control apparatus 1 and storing it in the storage unit 42.

The VM server 4 updates the contents of the server program setting file when the setting control section 44 periodically refers to the contents of the configuration data DB 2 and detects an update. In more detail, the resource data solving section 441 of the setting control section 44 outputs the contents of the setting file based on the contents of the configuration data DB 2 and the setting file template 462. When the outputted contents (new contents) are different from the contents of the current setting file 463, the setting updating section 442 replaces the contents of the setting file 463 by the new contents. When the contents of the setting file 463 are replaced by the new contents, the update notifying section 443 notifies a setting change to the server program 45 using the setting file 463.

Next, a more detailed operation procedure of the setting control section 44 will be described.

### <Operation Procedure of VM Server 4/VA Instance/Setting Control Section 44>

Referring to FIG. 18, a detailed operation procedure of the setting control section 44 of the VA instance will be described. The setting control section 44 performs the following procedure for each predetermined time period.

### (1) Step S501

The setting control section 44 checks whether any update on the configuration data DB 2 is present. At this time, the resource data solving section 441 inquires to the configuration data DB 2, whether the contents of the configuration data DB 2 were updated after the contents of the server program setting file 463 were updated in a previous time.

### (2) Step S502

If there is no update on the configuration data DB 2, the setting control section 44 ends the process. That is, if the contents of the configuration data DB 2 were not updated, the resource data solving section 441 ends the process.

### (3) Step S503

The setting control section 44 generates a provisional setting file from the setting file template. At this time, the resource data solving section 441 generates the provisional setting file by referring to the self-identification data 461, the setting file template 462, and data stored in the configuration data DB 2.

### (4) Step S504

The setting control section 44 checks whether the contents of the current setting file coincide with the contents of the provisional setting file, and ends the process when they coincide with each other. At this time, the setting updating section 442 compares the contents of the provisional setting file and the contents of the current server program setting file 463, and ends the process when they coincide with each other.

### (5) Step S505

When the contents of the current setting file do not coincide with the content of the provisional setting file, the setting control section 44 replaces the contents of the setting file by the contents of the provisional setting file. At this time, the setting updating section 442 replaces the contents of the current server program setting file 463 by the contents of the provisional setting file.

### (6) Step S506

The setting control section 44 notifies a setting update to the server program 45. At this time, the setting updating section 442 instructs the update notifying section 443 to perform notification. In response to the instruction from the setting updating section 442, the update notifying section 443 notifies to the server program 45, that the setting file has been updated. The server program 45 validates the updated contents in response to this notification.

A specific operation procedure at the step S503 is similar to the resource data solving process (step S404 to step S407 of FIG. 16) in the VM image generating section 14 of the virtual appliance control apparatus 1. However, this process procedure is different in that the self-identification data 461 is referred to in order to obtain an ID of a VA instance to be set.

The VM image generating section 14 and the resource data solving section 441 are different in role rather than in function.

In the VM image generating section 14, edition of the setting file for a virtual machine monitor and an environment constructing mechanism supported by an OS (Operating System) are considered. As an example of the setting file for the virtual machine monitor, there are a MAC address and IP address assigned to a VM. As an example of the environment constructing mechanism supported by the OS, there is “Sysprep” in “Windows (registered trademark)”. In particular, settings regarding a network are required to be made from outside of the VA. It should be noted that, in addition to the exemplary embodiments described herein, an exemplary embodiment is possible in which a VM image template is transmitted to the VM server 4 and then the setting file generating process similar to the above is executed on the VM server 4.

In the resource data solving section 441, edition of a setting file for an application operating on a VA is a main target. Usually, the edition of the setting file for the application is not supported by the virtual machine monitor or the functions of the OS, and therefore, the edition of the setting file for the application is required to be performed by the setting control section 44 on the VA after the VA starts once. It should be noted that a VM of some type can operate a VM image from outside as a file system and directly rewrite the setting file. Therefore, an exemplary embodiment is possible in which updates of all the setting files are performed (externally) from outside of the VA.

### <Operation Procedure of Name Server 5>

The name server 5 uses a correspondence table of a host name and an IP address as the name server setting file 533. For updating the correspondence table according to deployment of a VA instance, the setting control section 51 periodically refers to the contents of the configuration data DB 2 and, when the contents of the configuration data DB 2 are changed, updates the contents of the name server setting file 533.

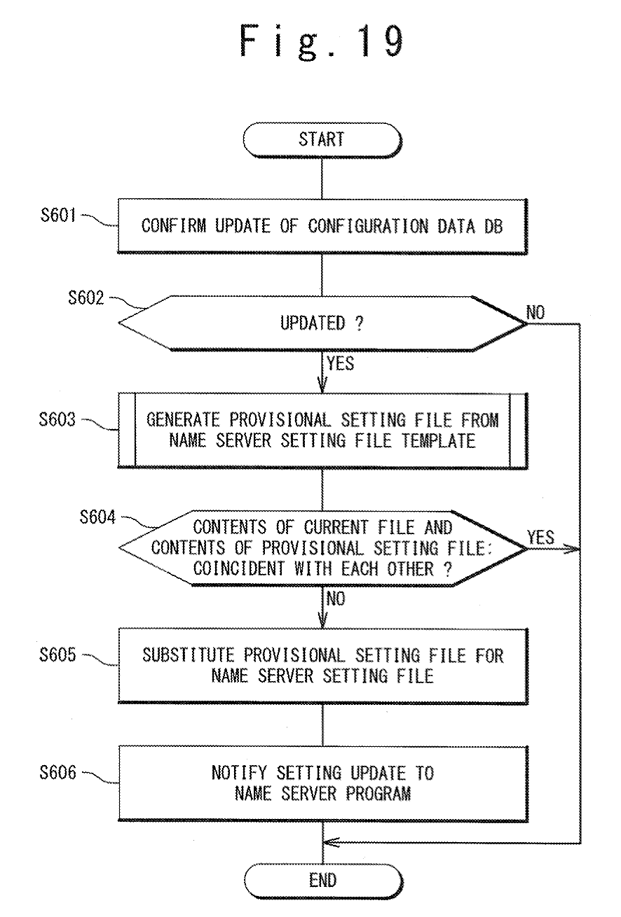

A specific process procedure of the setting control section 51 is shown in FIG. 19.

### (1) Step S601

The setting control section 51 checks whether the update of the configuration data DB 2 has been performed or not. At this time, the resource data solving section 511 inquires to the configuration data DB 2, whether the contents of the configuration data DB 2 were updated after the contents of the name server program setting file 533 were updated in the previous time.

### (2) Step S602

If there is no update of the configuration data DB 2, the setting control section 51 ends the process. That is, if the contents of the configuration data DB 2 were not updated, the resource data solving section 511 ends the process.

### (3) Step S603

The setting control section 51 generates a provisional setting file from the name server setting file template. At this time, the resource data solving section 511 generates the provisional setting file by referring to the self-identification data 531, the name server setting file template 532, and data stored in the configuration data DB 2.

### (4) Step S604

The setting control section 51 checks whether the contents of the current setting file coincide with the contents of the provisional setting file, and ends the process when they coincide with each other. At this time, the setting updating section 512 compares the contents of the provisional setting file and the contents of the current name server program setting file 533, and ends the process when they coincide with each other.

### (5) Step S605

When the contents of the current setting file do not coincide with the contents of the provisional setting file, the setting control section 51 replaces the contents of the setting file by the contents of the provisional setting file. At this time, the setting updating section 512 replaces the contents of the current name server program setting file 533 by the contents of the generated provisional setting file.

### (6) Step S606

The setting control section 51 notifies a setting update to the name server program 52. At this time, the setting updating section 512 instructs the update notifying section 513 to execute notification. The update notifying section 513 notifies that the setting file has been updated, to the name server program 52 in response to the instruction from the setting updating section 512. By this notification, the name server program 52 validates the updated contents.

The operation procedure depicted in FIG. 19 is similar to that of the setting control section 44 of the VA instance shown in FIG. 18, and only the different points are as follows:

(1) the template to be inputted is the name server setting file template 532 in place of the server program setting file template 462,

(2) the file to be replaced is the name server setting file 533 in place of the server program setting file 463, and

(3) the target for update notification is the name server program 52 in place of the server program 45.

These differences are merely superficial, and the procedures do not have any substantial difference.

### <Operation Procedure of Portal Web Server 6>

The portal Web server 6 retains electronic documents including a list of deployed services as the Web contents 633. For updating the Web contents according to deployment of VA instances, the setting control section 61 periodically refers to the contents of the configuration data DB 2, and updates the contents of the Web contents 633 when having been changed.

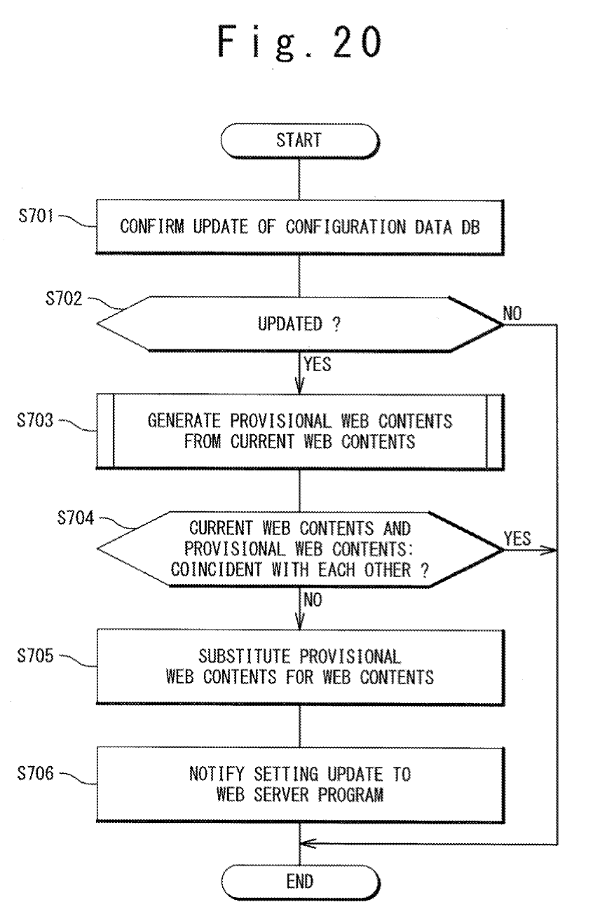

A specific process procedure of the setting control section 61 will be described in FIG. 20.

### (1) Step S701

The setting control section 61 checks whether update of the configuration data DB 2 has been performed or not. At this time, the resource data solving section 611 inquires to the configuration data DB 2, whether the contents of the configuration data DB 2 were updated after the contents of the Web contents 633 were updated in the previous time.

### (2) Step S702

If there is no update of the configuration data DB 2, the setting control section 61 ends the process. That is, if the contents of the configuration data DB 2 were not updated, the resource data solving section 611 ends the process.

### (3) Step S703

The setting control section 61 generates provisional Web contents from the Web contents template. At this time, the resource data solving section 611 generates the provisional Web contents by referring to the self-identification data 631, the Web contents template 632, and data stored in the configuration data DB 2.

### (4) Step S704

The setting control section 61 checks whether the contents of the current Web contents coincide with the contents of the provisional Web contents, and ends the process when the contents of the current Web contents coincide with the contents of the provisional Web contents. At this time, the setting updating section 612 compares the contents of the provisional Web contents and the contents of the current Web contents 633, and ends the process when the contents of the current Web contents coincide with the contents of the provisional Web contents 633.

### (5) Step S705

when the contents of the current Web contents do not coincide with the contents of the provisional Web contents, the setting control section 61 replaces the contents of the Web contents by the contents of the provisional Web contents. At this time, the setting updating section 612 replaces the contents of the current Web contents 633 by the contents of the provisional generated Web contents.

### (6) Step S706

The setting control section 61 notifies a setting update to the server program 62. At this time, the setting updating section 612 instructs the update notifying section 613 to perform notification. The update notifying section 613 notifies that the Web contents have been updated, to the Web server program 62 in response to the instruction from the setting updating section 612. By this notification, the Web server program 62 validates the updated contents.

The operation procedure shown in FIG. 20 is similar to that of the setting control section 44 of the VA instance shown in FIG. 18, and only the different points are as follows:

(1) The template to be inputted is the Web contents template 632 in place of the server program setting file template 462,

(2) The file to be replaced is the Web contents 633 in place of the server program setting file 463, and

(3) The target for update notification is the Web server program 62 in place of the server program 45.

These differences are merely superficial, and the procedures do not have any substantial difference.

Here, it is assumed in this description that the VM servers 4, the name server 5, and the portal Web server 6 are different server devices. However, in practice, these servers can be the same server unit. For example, it can be thought that one server causes a plurality of VMs having each of the functions of the VM servers 4, the name server 5, and the portal Web server 6 to operate.

Also, each of the setting control section 44 of the VA instance, the setting control section 51 of the name server 5, and the setting control section 61 of the portal Web server 6 can be independent as a setting managing server from the VM servers 4, the name server 5, and the portal Web server 6.

In an exemplary embodiment of the present invention, the setting control section 44 of the VA instance, the setting control section 51 of the name server 5, and the setting control section 61 of the portal Web server 6 are the same program to be executed by the same server unit. In the present exemplary embodiment, the different points are absorbed by specifying a file name to be inputted and outputted as a setting file for the setting control section.

Here, the virtual appliance deploying program of the present invention causes any of various computers to operate as each of components configuring the virtual appliance deploying system according the exemplary embodiments of the present invention. That is, the virtual appliance deploying program of the present invention causes any of various computers to perform the operation of each of the components configuring the virtual appliance deploying system and to execute the virtual appliance deploying method of the present invention. The virtual appliance deploying program of the present invention may be stored in a storage medium. For example, the virtual appliance deploying program of the present invention is read from a storage medium on a computer, and is executed by a CPU.

A first effect is that, in deploying a virtual appliance to a physical server, a setting operation depending on physical configuration and logic configuration can be automated, including a setting file required for a specific application. The reason is in that the resource data and the connection data stored in the configuration data DB can include an arbitrary attribute and that the resource data solving means generates the setting file containing specific resource data according to a single resource data solving procedure based on a setting file template including an arbitrary attribute.

A second effect is in that, in deploying the virtual appliance, description of the setting operation regarding external related services, such as a name server and a portal Web server, and the program for automating the setting operation is not required. The reason is in that, by the resource data solving means included in the name server or the portal Web server periodically referring to the contents of the configuration data DB, the setting file or the Web contents are updated on correspondence to the deployed virtual appliance.

That is, according to the present invention, it is possible to automatically and appropriately set a connection relation among the plurality of virtual appliances and a connecting relation between the virtual appliance and peripheral services.

The present invention can be applied for use in virtual appliance control software in a business system including a plurality of server devices and personal computers for clients.

While the exemplary embodiments of the present invention have been described above in detail, the present invention is not restricted to the exemplary embodiments described above, and modifications within a range not deviating the gist of the present invention are included in the present invention.

The present application claims a priority on convention based on Japanese Patent Application No. 2008-024394, and the disclosures thereof is incorporated herein by reference.

1. A virtual appliance deploying system comprising:
a virtual appliance control apparatus configured to acquire resource data to be assigned to a virtual appliance instance operating as a virtual machine and connection data with another virtual appliance instance and generate a virtual machine image based on said resource data and said connection data;
a configuration data database configured to store said resource data and said connection data;
a virtual machine server configured to generate and start said virtual appliance instance based on said virtual machine image; and
a setting control server configured to refer to said configuration data database to acquire said resource data and said connection data, generate a provisional setting file by replacing predetermined attribute values described in a setting file template related to said virtual appliance instance with specific setting values determined based on said resource data and said connection data and replace contents of an existing setting file with contents of said provisional setting file when the contents of said provisional setting file are different from those of said existing setting file.

2. The virtual appliance deploying system according to claim 1, wherein said virtual appliance control apparatus copies a virtual machine image setting file template stored in a virtual machine image repository, and refers to said resource data and said connection data to generate said virtual machine image by replacing said predetermined attribute values described in said copied virtual machine image setting file template with the specific setting values.

3. The virtual appliance deploying system according to claim 2, wherein said virtual appliance control apparatus comprises:
a resource data storage section configured to acquire said resource data from a user terminal to store in said configuration data database;
a connection data storage section configured to acquire said connection data from said user terminal to store in said configuration data database;
a virtual machine image generating section configured to copy said virtual machine image setting file template, and refer to said resource data and said connection data to generate said virtual machine image by replacing the predetermined attribute values described in said copied virtual machine image setting file template with the specific setting values; and
a virtual machine image transmitting section configured to transmit said virtual machine image to said virtual machine server.

4. The virtual appliance deploying system according to claim 1, wherein said setting control server comprises:
a resource data solving section configured to generate said provisional setting file based on said resource data and said connection data by referring to said configuration data database periodically; and
a setting updating section configured to replace the contents of said setting file with those of said provisional setting file when the contents of said provisional setting file are different from those of said setting file.

5. The virtual appliance deploying system according to claim 1, wherein said setting control server refers to said configuration data database to acquire said resource data and said connection data, generates a provisional server program setting file by replacing the predetermined attribute values described in a server program setting file template with the specific setting values determined based on said resource data and said connection data, replaces the contents of an existing server program setting file with those of said provisional server program setting file when the contents of said provisional server program setting file are different from those of said existing server program setting file, and notifies a setting change to said virtual machine server to validate the setting change.

6. The virtual appliance deploying system according to claim 1, further comprising:
a name server configured to perform mutual conversion between an IP address and a host name of said virtual appliance instance,
wherein said setting control server refers to said configuration data database to acquire said resource data and said connection data, generates a provisional name server setting file by replacing the predetermined attribute values described in a name server setting file template with the specific setting values determined based on said resource data and said connection data, replaces the contents of an existing name server setting file with those of said provisional name server program setting file when the contents of said provisional server setting file are different from those of said existing name server setting file, and notifies a setting change to said name server to validate the setting change.

7. The virtual appliance deploying system according to claim 1, further comprising:
a Web server having a service provided by said virtual appliance instance as Web contents,
wherein said setting control server refers to said configuration data database to acquire said resource data and said connection data, generates provisional Web contents by replacing the predetermined attribute values described in a Web contents template with the specific setting values determined based on said resource data and said connection data, replaces existing Web contents with said provisional Web contents when said provisional Web contents are different from said existing Web contents, and notifies a setting change to said Web server to validate the setting change.

8. (canceled)

9. (canceled)

10. A virtual appliance deploying method comprising:
acquiring resource data to be assigned to a virtual appliance instance operating as a virtual machine and connection data with another virtual appliance instance to generate a virtual machine image based on said resource data and said connection data;
distributing said virtual machine image to a virtual machine server;
storing said resource data and said connection data in a configuration data database;
generating and starting said virtual appliance instances based on said virtual machine image;
referring to said configuration data database to acquire said resource data and said connection data to generate a provisional setting file by replacing predetermined attribute values described in a setting file template related to said virtual appliance instance with specific setting values determined based on said resource data and said connection data; and
replacing contents of an existing setting file with contents of said provisional setting file when the contents of said provisional setting file are different from those of said setting file.

11. The virtual appliance deploying method according to claim 10, further comprising:
copying a virtual machine image setting file template stored in a virtual machine image repository; and
generating said virtual machine image by replacing said predetermined attribute values described in said copied virtual machine image setting file template with the specific setting values determined based on said resource data and said connection data.

12. The virtual appliance deploying method according to claim 10, wherein said storing comprises:
acquiring said resource data from a user terminal to store in said configuration data database;
acquiring said connection data from said user terminal to store in said configuration data database, and
said method further comprises:
distributing said virtual machine image to a virtual machine server.

13. The virtual appliance deploying method according to claim 10, wherein said referring to said configuration data database comprises:
referring to said configuration data database periodically to generate said provisional setting file by using said resource data and said connection data.

14. The virtual appliance deploying method according to claim 10, wherein said referring to said configuration data database comprises:
referring to said configuration data database to acquire said resource data and said connection data to generate a provisional server program setting file by replacing the predetermined attribute values described in a server program setting file template with the specific setting values determined based on said configuration data databases,
wherein said replacing comprises:
replacing the contents of an existing server program setting file with those of said provisional server program setting file when the contents of said provisional server program setting file are different from those of said existing server program setting file, and
wherein said method further comprises:
notifying a setting change to said virtual machine server to validate the setting change.

15. The virtual appliance deploying method according to claim 10, wherein referring to said configuration data database:
referring to said configuration data database to acquire said resource data and said connection data to generate a provisional name server setting file by replacing the predetermined attribute values described in a name server setting file template with the specific setting values determined based on said configuration data database,
wherein said replacing comprises:
replacing the contents of an existing name server setting file with those of said provisional name server program setting file when the contents of said provisional server setting file are different from those of said existing name server setting file, and
wherein said method further comprises:
notifying a setting change to a name server to validate the setting change.

16. The virtual appliance deploying method according to claim 10, wherein referring to said configuration data database:
referring to said configuration data database to acquire said resource data and said connection data to generate provisional Web contents by replacing the predetermined attribute values described in said Web contents template with the specific setting values determined based on said configuration data database,
wherein said replacing comprises:
replacing existing Web contents with said provisional Web contents when said provisional Web contents are different from said existing Web contents, and
wherein said method further comprises:
notifying a setting change to a Web server to validate the setting change.

17. A computer-readable non-transitory medium in which a computer-executable program code is stored to attain a virtual appliance deploying method which comprises:
acquiring resource data to be assigned to a virtual appliance instance operating as a virtual machine and connection data with another virtual appliance instance to generate a virtual machine image based on said resource data and said connection data;
distributing said virtual machine image to a virtual machine server;
storing said resource data and said connection data in a configuration data database;
generating and starting said virtual appliance instances based on said virtual machine image;
referring to said configuration data database to acquire said resource data and said connection data to generate a provisional setting file by replacing predetermined attribute values described in a setting file template related to said virtual appliance instance with specific setting values determined based on said resource data and said connection data; and
replacing contents of an existing setting file with contents of said provisional setting file when the contents of said provisional setting file are different from those of said setting file.
